(19) United States
(12) Patent Application Publication
(10) Pub. No.: US 2018/0248418 A1
(43) Pub. Date: Aug. 30, 2018

(54) STATOR OF A ROTARY ELECTRICAL MACHINE WITH AN OPTIMISED FILLING PROPORTION

(71) Applicant: Valeo Equipements Electriques Moteur, Creteil (FR)

(72) Inventors: Benoit WALME, Créteil (FR); Mamy RAKOTOVAO, Créteil (FR); Rafal PISAREK, Creteil (FR)

(73) Assignee: Valeo Equipements Electriques Moteur, Creteil (FR)

(21) Appl. No.: 15/758,996

(22) PCT Filed: Sep. 7, 2016
(86) PCT No.: PCT/FR2016/052226

§ 371 Date: Mar. 9, 2018

(30) Foreign Application Priority Data
Sep. 11, 2015 (FR) 1558469

(51) Int. Cl. H02K 1/14; H02K 1/27; H02K 3/18; H02K 3/32

(52) U.S. Cl. CPC H02K 1/146; H02K 1/276; F04D 25/06; H02K 3/325; H02K 2213/03; H02K 3/18

(57) ABSTRACT

The invention mainly concerns a stator (9) of a rotary electric machine, in particular intended for an electric compressor for a motor vehicle, said stator (9) comprising a body (16) having: —a yoke (28), —a plurality of teeth (27) angularly distributed on an inner periphery of said yoke (28), —a winding (17) comprising a plurality of coils (50), each coil (50) being formed by a wire (51) wound around a tooth (27), characterised in that a ratio between a diameter of a conductive portion of said wire (51) and an inner diameter of said stator (9) is of between 3% and 10%.

The invention relates to a stator of a rotary electrical machine with an optimised filling proportion. The invention has a particularly advantageous, but not exclusive, application with electrical compressors of motor vehicles.

In a known manner, rotary electrical machines comprise a stator and a rotor integral with a shaft. The rotor can be integral with a driving and/or driven shaft, and can belong to a rotary electrical machine in the form of an alternator, an electric motor, or a reversible machine which can function in both modes.

The rotor comprises a body formed by a stack of metal plate sheets retained in the form of a set by means of an appropriate securing system. The rotor comprises poles formed by permanent magnets accommodated in cavities provided in the rotor body.

In addition, the stator is fitted in a housing which is configured to rotate the shaft, for example by means of bearings. The stator comprises a body constituted by a stack of thin metal plates forming a yoke in the form of a ring, the inner face of which is provided with notches open towards the interior in order to receive phase windings.

In a winding of the distributed undulating type, the windings are obtained for example from a continuous wire covered with enamel, or from conductive elements in the form of pins which are connected to one another by welding. Alternatively, in a winding of the “concentric” type, also known as the “concentrated” type, the phase windings are constituted by coils closed on themselves which are wound around teeth of the stator. These windings are polyphase windings connected in the form of a star or a triangle, the outputs of which are connected to control electronics.

Document EP1089417A2 is known which describes a stator of a rotary electrical machine.

Electrical machines are known which are coupled to a shaft of an electrical compressor. This electrical compressor makes it possible to compensate at least partly for the loss of power of the thermal engines with a reduced cubic capacity used on many motor vehicles in order to reduce their consumption and the emissions of pollutant particles (so-called downsizing principle). For this purpose, the electrical compressor comprises a turbine arranged on the intake duct upstream or downstream from the thermal engine, in order to make it possible to compress the air, so as to optimise the filling of the cylinders of the thermal engine. The electrical machine is activated in order to drive the turbine, so as to minimise the torque response time, in particular during transient phases in acceleration, or in the phase of automatic restarting of the thermal engine after standby mode (stop and start functioning).

However, taking into account the small dimensions of the electrical machine and the high performance levels required, it is difficult to provide the different elements with an optimum size, in particular the body of the stator and the corresponding winding wire, in order to obtain an optimum filling proportion of the notches.

The objective of the present invention is in particular to eliminate this difficulty by proposing a stator of a rotary electrical machine, which machine is in particular designed for an electrical compressor for a motor vehicle, the stator comprising:
a body with:
   a yoke;
   a plurality of teeth distributed angularly on an inner periphery of the said yoke, with two adjacent teeth defining a notch between one another; and
a winding comprising a plurality of coils, each coil being formed by a wire wound around a tooth,
   characterised in that a ratio between a diameter of a conductive portion of the said wire and an inner diameter of the said stator is contained between 3 and 10%, for example between 5 and 10%, in particular between 5 and 7%.

The invention thus makes it possible to obtain an optimum compromise between the inertia of the electrical machine and the proportion of filling of the notches of the stator.

The ratio between a diameter of a conductive portion of the wire and an inner diameter of the stator can be contained between 5.2% and 6.3%.

According to one embodiment, the said ratio is substantially equal to 5.4%.

According to one embodiment, the said diameter of the said conductive portion of the said wire is contained between 1 mm and 2 mm. With the layer of enamel, the diameter of the wire is 1.602 mm. The choice of the diameter of the wire is an important choice for ensuring the feasibility of a winding of a concentric type. In addition, the choice of the inner diameter of the stator is guided by the minimisation of the inertia (or the maximisation of 1/inertia) which is optimum when this ratio is close to 1, as well as by the feasibility of the winding. In fact, the more the inner diameter of the stator increases, the more the outer diameter of the rotor increases, and the more the inertia increases.

According to one embodiment, the said inner diameter of the said stator is approximately 26.8 mm.

According to one embodiment, each notch has a filling proportion of approximately:
50% when the said proportion is calculated according to a first calculation method, wherein there is determination of a ratio between the cumulative total surface area of conductor, including its insulating layer, and a total surface area of the notch, with deduction of a space occupied by a notch insulator; or
73% when the said proportion is calculated according to a second calculation method, corresponding to the first method, except that the surface area of a cross-section for the passage of a winding needle is deducted from the surface area of notch cross-section.

According to one embodiment, the said winding is of the in situ type.

According to one embodiment, a proportion between a diameter of a conductive portion of the said non-enameled wire, expressed in mm, and a number of turns of each coil, is contained between 5% and 25%, in particular between 10% and 20%. This makes it possible to optimise the magnetic performance of the electrical machine, whilst facilitating the insertion of the winding needle inside the notches, in order to form the coils around teeth of the stator, within the context of a winding of a concentric type.

According to one embodiment, each coil is formed by a number of turns contained between 5 and 20.

According to one embodiment, each coil is formed by 9 turns.

As a variant, each coil is formed by 18 turns.

According to one embodiment, the said stator comprises 6 coils.

According to one embodiment, the said winding is of the three-phase type, each phase being formed in particular by two diametrically opposite coils.

According to one embodiment, the said coils are connected electrically in pairs in parallel.

According to one embodiment, the said coils are coupled in the form of a triangle. Coupling of this type makes it possible to minimise the number of connections to be formed.

According to one embodiment, around each tooth, a number of turns situated on the side of the said yoke is larger than a number of turns situated on the side of an axis of the said stator.

According to one embodiment, in a notch, a portion of the coil filling the said notch is formed by three layers of turns. As a variant, it would be possible to form two layers of turns.

According to one embodiment, a ratio between a smaller notch opening measured between two adjacent tooth roots, and an outer diameter of the said stator, is contained between 5% and 25%, in particular between 5% and 15%. This makes it possible to optimise the magnetic performance of the electrical machine whilst facilitating the insertion of the winding needle inside the notches, in order to form the coils around the teeth of the stator.

According to one embodiment, the said stator body is composed of a plurality of metal plate sheets superimposed axially on one another.

According to one embodiment, at least one sheet comprises on its surface a stud which is designed to cooperate with a hollow in an adjacent sheet, and a ratio between a larger diameter of the said stud and an outer diameter of the said stator is contained between 5% and 15%, in particular between 2% and 10%. A ratio of this type makes it possible not to disrupt the magnetic flux to the stator, whilst guaranteeing good mechanical resistance of the set of metal plates of a stator of this type with reduced dimensions.

According to one embodiment, the said stator body comprises at least one through securing hole which opens on the side of each axial end face of the said stator body, and a ratio between a first distance between an axis of the said stator and an axis of the said securing hole, and half an outer diameter of the said stator, is contained between 80% and 97%, in particular between 85% and 95%. This therefore makes it possible to obtain an optimum compromise between good mechanical resistance and the magnetic performance of the electrical machine in which the stator is fitted.

According to one embodiment, the said machine comprises a rotor provided with embedded permanent magnets, of which there are for example four.

According to one embodiment, the said rotor body has an outer periphery delimited by a cylinder face with an outer diameter contained between 20 mm and 50 mm, in particular contained between 24 mm and 34 mm, and preferably approximately 28 mm.

According to one embodiment, the said machine has a response time contained between 100 ms and 600 ms, in particular contained between 200 ms and 400 ms, for example being approximately 250 ms, in order to go from 0 or 5,000 to 70,000 rpm.

According to one embodiment, positioning elements are interposed between the rotor body and each permanent magnet.

The subject of the invention also is a rotary electrical machine comprising a stator as previously described and a rotor provided with embedded permanent magnets.

The invention will be better understood by reading the following description and examining the figures which accompany it. These figures are provided purely by way of illustration of the invention which is in no way limiting.

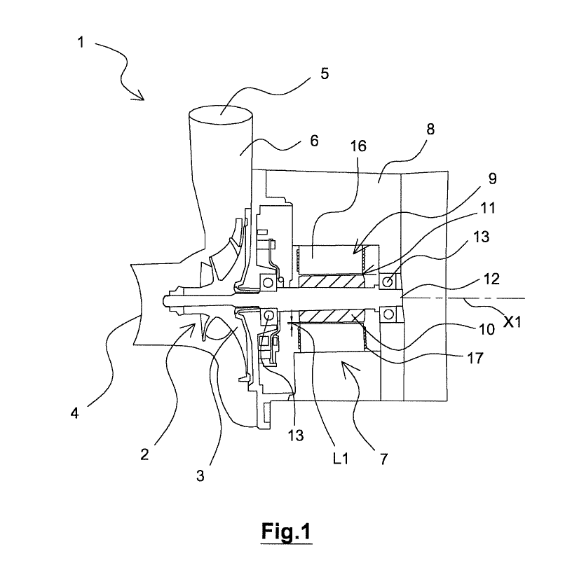

FIG. 1 is a view in cross-section of an electrical compressor comprising a rotary electrical machine according to the present invention;

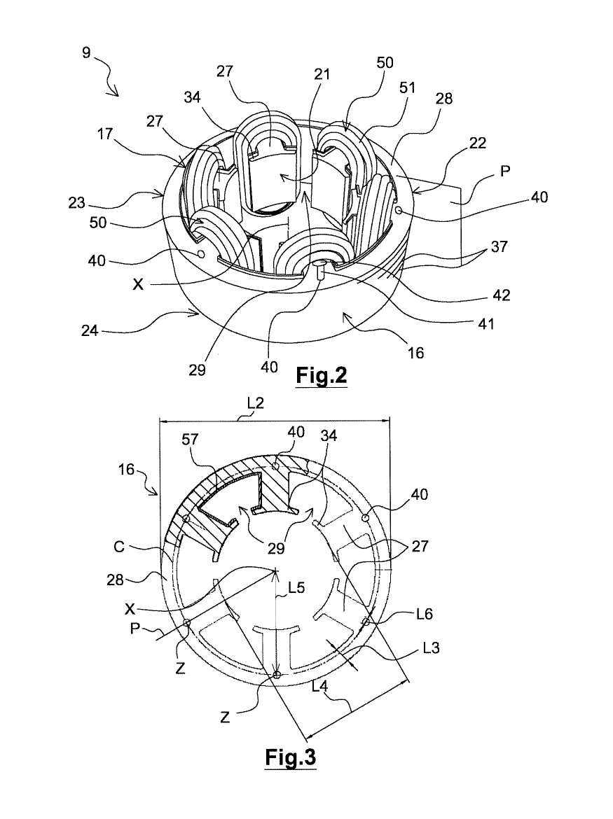

FIG. 2 shows a view in perspective of the stator of the rotary electrical machine according to the present invention;

FIG. 3 is a view from above of the stator alone of the rotary electrical machine according to the present invention;

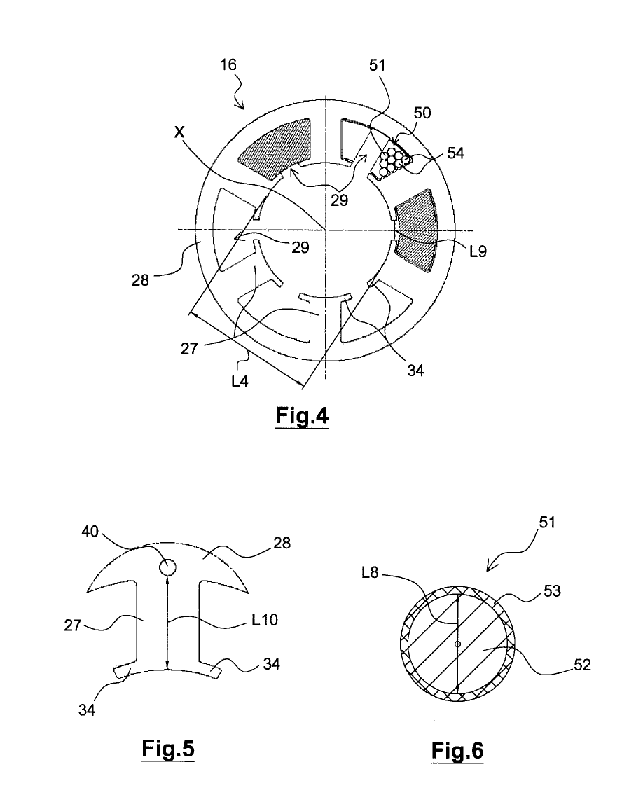

FIG. 4 is a view from above of the stator according to the invention provided with turns for the formation of a portion of coil occupying a half notch;

FIG. 5 shows a view in partial cross-section illustrating the configuration of a tooth of the stator according to the present invention;

FIG. 6 is a view in cross-section of a wire used for the formation of a coil belonging to the winding of the stator according to the present invention;

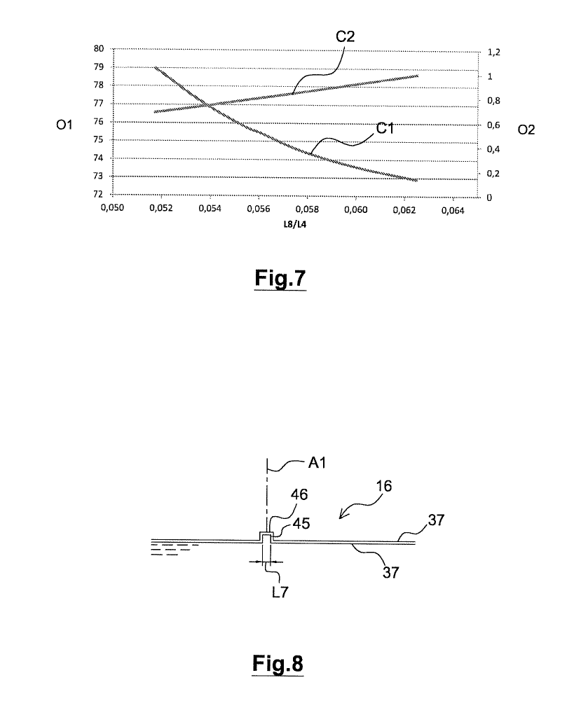

FIG. 7 shows a development of the proportion of filling (01) as a percentage, as well as the inverse of the inertia of the machine (02) according to the ratio between the diameter of a conductive portion of the winding wire and the inner diameter of the stator;

FIG. 8 is a view in cross-section illustrating nesting between the sheets of metal plates of the stator in the case of assembly by buttoning;

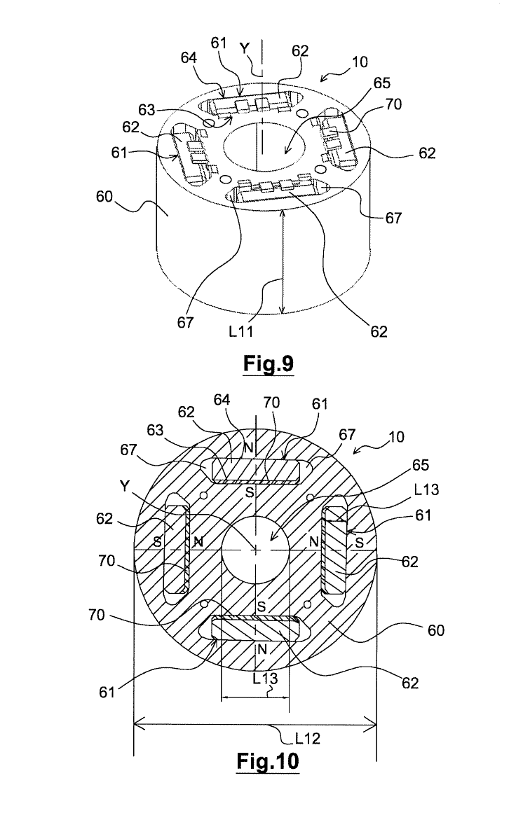

FIG. 9 shows a view in perspective of the rotor of the rotary electrical machine according to the present invention;

FIG. 10 is a view in transverse cross-section of the rotor of the rotary electrical machine according to the present invention.

Elements which are identical, similar or analogous retain the same reference from one figure to another.

FIG. 1 shows an electrical compressor 1 comprising a turbine 2 provided with fins 3 which, via an input 4, can aspirate non-compressed air obtained from a source of air (not represented) and discharge compressed air via the output 5 after passage into a volute with the reference 6. The output 5 can be connected to an intake distributor (not represented) situated upstream from the thermal engine, in order to optimise the filling of the cylinders of the thermal engine. In this case, the intake of the air is carried out in an axial direction, i.e. along the axis X1 of the turbine 2, and the discharge is carried out in a radial direction perpendicular to the axis X1 of the turbine 2. As a variant, the aspiration is radial, whereas the discharge is axial. Alternatively, the aspiration and the discharge are carried out in the same direction relative to the axis of the turbine (axial or radial).

For this purpose, the turbine 2 is driven by an electrical machine 7 fitted inside the housing 8. This electrical machine 7 comprises a stator 9 which can be polyphase, surrounding a rotor 10 with the presence of an air gap 11. This stator 9 is fitted in the housing 8 which is configured to rotate a shaft 12 by means of bearings 13. The shaft 12 is connected in rotation to the turbine 2 and to the rotor 10. The stator 9 is preferably fitted in the housing 8 by banding.

In order to minimise the inertia of the turbine 2 during a requirement for acceleration by the driver, the electrical machine 7 has a short response time contained between 100 ms and 600 ms, in particular contained between 200 ms and 400 ms, for example being approximately 250 ms, in order to go from 0 or 5,000 to 70,000 rpm. Preferably, the voltage of use is 12 V. Preferably, the electrical machine 7 can supply a current spike, i.e. a current provided for a continuous duration of less than 3 seconds, contained between 150 A and 300 A, in particular between 180 A and 250 A.

As a variant, the electrical machine 7 can function in alternator mode, or it is an electrical machine of the reversible type.

As can be seen in FIG. 2, the stator 9 comprises a body 16 and a winding 17. The stator body 16 has an annular cylindrical form with an axis X, and consists of an axial stack of flat metal plates. More specifically, the stator body 16 is delimited radially by an inner cylindrical face 21 and an outer cylindrical face 22. The body 16 is also delimited axially by end faces 23 and 24.

The body 16 comprises teeth 27 which are distributed angularly regularly around an inner circumference of a yoke 28. These teeth 27 delimit notches 29, such that each notch 29 is delimited by two successive teeth 27. The yoke 28 thus corresponds to the solid outer annular portion of the body 16 which extends between the base of the notches 29 and the outer periphery of the stator 9.

The notches 29 open axially into the axial end faces 23, 24 of the body 16. The notches 29 are also open radially in the inner cylindrical face of the body 16.

As can be seen clearly in FIGS. 3 and 4, the teeth 27 of the stator 9 preferably have parallel edges, such that the inner faces opposite one another of the notches 29 are inclined relative to one another. The notches 29 are distributed angularly regularly around the axis X.

Preferably, the stator 9 is provided with tooth roots 34 on the side of the free ends of the teeth 27 (cf. FIG. 5). Each tooth root 34 extends circumferentially on both sides of a corresponding tooth 27.

The stator 9 is a non-segmented part consisting of laminated metal plates made of magnetic material. In addition, the teeth 27 are integral with the yoke 28. As a variant, the stator 9 can however be segmented, i.e. it is formed from a plurality of angular segments assembled to one another. In this case, the yoke 28 has continuity of material radially according to its circumference and radially throughout its thickness. As a variant, the teeth 27 can be added on relative to the yoke 28, and secured on the inner periphery of the yoke by means of a system of the tenon-mortise type.

Advantageously, a ratio between a radial thickness L1 of the air gap 11 and an outer diameter L2 of the stator 9 is contained between 0.1% and 2%, in particular between 0.2% and 1%. This ratio makes it possible to maximise the torque developed by this type of machine provided with a stator 9 with small dimensions. The air gap 11 is selected according to a thickness L13 of permanent magnets 62 of the rotor 10 (cf. FIG. 10). Thus, a second ratio between a thickness of the air gap 11 and a thickness of magnets L13 is contained between 0.9 and 0.15.

In addition, in order to optimise the passage of the magnetic flux in the stator 9, whilst having efficient mechanical resistance, a ratio between a thickness L3 of the yoke 28 measured radially, and an inner diameter L4 of the stator 9 measured between two diametrically opposite teeth 27, is contained between 9% and 20%, for example between 10% and 20%, in particular between 12% and 15%, and is preferably approximately 9% or 13%.

In addition, a ratio between the inner diameter L4 and an outer diameter L2 of the stator 9 is contained between 40% and 60%, and is preferably approximately 51.5%. This makes it possible to optimise the space which can be wound of the notches 29, as well as the inertia of the rotor 10.

As can be seen in FIG. 2, the stator body 16 is preferably formed by an axial stack of metal plate sheets 37 each extending on a radial plane perpendicular to the axis X. This stator body 16 is made of ferromagnetic material. The metal plates 37 are retained by securing means 41 for formation of an assembly which can be manipulated and transported. For this purpose, a plurality of securing holes 40 are provided in the stator body 16, in order each to permit the passage of a means 41 for securing of the metal plates of the stator body 16. In this case, the securing holes 40 are preferably through holes, i.e. they open axially onto each of the axial ends 23, 24 of the stator body 16, such that it is possible to pass inside each securing hole 40 a rod 41 which is or is not provided with a head 42 at one of its ends, and the other end of which, or both ends of which, will be deformed for example by a heading process in order to ensure the axial retention of the set of plates.

Advantageously, a ratio between a distance L5 between the axis X of the stator 9 and an axis Z of a securing hole 40 (cf. FIG. 3) and half of the outer diameter L2 of the stator 9 is contained between 80% and 97%, and in particular between 85% and 95%. This makes it possible to obtain an optimum compromise between good mechanical resistance and the magnetic performance of the electrical machine 7 in which the stator 9 is fitted. The axis Z of each securing hole 40 is contained on a plane of symmetry P of a corresponding tooth 27. The axes Z of the securing holes 40 are also preferably positioned on a single circle C (cf. FIG. 3).

The stator 9 comprises a number of securing holes 40 contained between three and the number of teeth 27, in this case equal to six. In addition, the securing holes 40 pass through the yoke 28, in particular passing through only the yoke 28, i.e. without encroaching on the corresponding tooth 27. A ratio between the maximum diameter L6 of each securing hole 40 and the outer diameter L2 of the stator 9 is contained between 2% and 10%.

As a variant, the rod 41 is without a head 42, and the two ends are then deformed by a heading process. As a variant, the securing holes 40 can have a cross-section with a form which is square, rectangular, or any other form suitable for the passage of the securing means 41.

As a variant, the metal plates can be held together by buttoning, or adhesion, or laser welding.

In the embodiment in FIG. 8, each sheet 37 comprises on its surface a stud 45 which is designed to cooperate with a hollow 46 in an adjacent sheet. The final sheet is pierced. A ratio between the largest diameter L7 of the stud 45 and an outer diameter L2 of the stator 9 is contained between 5% and 15%, in particular between 2% and 10%. A ratio of this type permits good mechanical resistance of the set of plates of a stator 9 of this type with reduced dimensions, whilst limiting the magnetic disturbances associated with the presence of the studs 45. In addition, a ratio of this type makes it possible to facilitate the production of the sheets 37, whilst ensuring precise positioning of one sheet 37 relative to the other.

Each metal plate sheet 37 comprises at least one face which is directly in contact with a single face of another sheet 37. Preferably, the largest diameter of each stud 45 is contained between 0.5 mm and 5 mm, and is preferably 3 mm. The number of studs 45 per sheet 37 is contained between two and the number of teeth of the stator 9. On a metal plate sheet 37, the studs 45 are arranged on a first face, and the hollows 46 are arranged in a second face opposite the first face. In addition, each hollow 46 is aligned axially with a corresponding stud 45 according to an axis with the reference A1 in FIG. 8. According to one embodiment, the studs 45 on the sheet are positioned in the middle of each tooth 27, and on the same diameter, for example of approximately 47 mm. As a variant, the yoke 28 is solid, and has continuity of material radially according to its circumference and radially throughout its thickness.

As can be seen in FIGS. 2 and 4, in order to form the winding 17 of the stator 9, a plurality of phase windings, in this case six of them, are formed by coils 50 wound around teeth 27 of the stator 9. Each coil 50 is formed from a wire 51. This wire 51, which is shown in cross-section in FIG. 6, is provided with a conductive portion 52, farmed by copper or aluminium for example, covered with an insulating layer 53, such as enamel.

FIG. 7 shows a development of the proportion of filling (curve C1) as well as the inverse of the inertia of the machine (curve C2), according to the ratio between the diameter L8 of a conductive portion of the said wire 51 and the inner diameter L4 of the stator 9. The ratio is contained between 3 and 10%, for example between 5 and 10%, in particular between 5 and 7%, for example between 5.2% and 6.3%. Preferably, the ratio is substantially equal to 5.4%, which corresponds to the intersection between the two curves C1 and C2. It should be noted that the ratio is varied with a fixed diameter L8 of approximately 1.5 mm. In addition, the other parameters of the stator and of the rotor which are fixed in order to obtain the curves are contained in the ranges given in the embodiment indicated below.

The diameter L8 of the conductive portion of the wire 51 is approximately 1.5 mm in the case when the stator comprises 9 turns. With the layer of enamel, the diameter of the wire is 1.602 mm. As a variant, the diameter L8 of the conductive portion of the wire 51 is approximately 1.06 mm in the case when the stator comprises 18 turns. The choice of the diameter of the wire 51 is a choice which is important for ensuring the feasibility of a winding of a concentric type. In addition, the choice of the inner diameter L4 of the stator is guided by the minimisation of the inertia (or maximisation of 1/inertia which is optimum when this ratio is close to 1), as well as by the feasibility of the winding. In fact, the more the inner diameter of the stator 9 increases, the more the outer diameter of the rotor increases, and the more the inertia increases.

According to the calculation method, this stator can thus have a proportion of notch filling of approximately:
50% when it is calculated according to a first calculation method, in which there is determination of a ratio between the cumulative total surface area (in cross-section) of copper in the notch, with assimilation of the enamel as copper, and the total surface area of the notch (with deduction of the space occupied by the insulator, and starting from the principle that the wire has a square cross-section); or
73% when it is calculated according to a second calculation method corresponding to the first method, except that the surface area of the cross-section for the passage of the winding needle is deducted from the surface area of notch cross-section. The result provided by this second method is a so-called “useful” level of filling.

The table below shows the proportion of filling with the aforementioned two methods:
First method:

| | | |
|---|---|---|
| | Surface area of wire in the | 46.195272 |
| | notch (diameter on the square × | |
| | no. of wires × 2) = | |
| Total proportion of | Surface area of wire in the | 49.82932465 |
| filling | notch/surface area of the | |
| | insulated notch | |

Second method:

| | | |
|---|---|---|
| | Surface area of wire in the | 23.097636 |
| | notch (diameter on the square × | |
| | no. of wires) = | |
| Useful proportion of | Surface area of wire in the | 73.32582857 |
| filling | notch/useful surface area of | |
| | the insulated notch | |

In addition, preferably, a ratio between a smaller notch opening L9 measured between two adjacent tooth roots 34 (cf. FIG. 4) and the outer diameter L2 of the stator 9 is contained between 5% and 25%, in particular between 5% and 15%. This therefore facilitates the insertion of the winding needle inside the notch 29.

Around each tooth 27, the number of turns 54 situated on the yoke 28 side is greater than, or equal to, the number of turns 54 situated on the axis X side of the stator 9. It will be remembered here that a turn 54 corresponds to a revolution of the wire around the tooth 27. In a given notch 29, the portion of the coil 50 filling the notch 29 is formed for example by three layers of turns 54. In each layer, the turns 54 are positioned side by side. Each coil 50 is preferably formed by nine turns 54.

In this case, the winding 17 is of the three-phase type, each phase being formed in particular by two diametrically opposite coils 50. The diametrically opposite coils 50 are connected electrically in pairs in parallel. The phases which are each formed by two coils 50 in parallel are preferably connected in the form of a triangle. This type of winding makes it possible to minimise the number of connections to be formed. In addition, it should be noted that with a low voltage, the choice of the number of wires and of the coupling of the coils 50 is very restrictive, in that, to within one turn 54, it can become impossible to achieve the performance levels required, in particular in terms of acceleration of the machine.

In the invention, the configuration with nine turns 54 in the form of a triangle makes it possible to fulfil the technical requirements of the compressor, whereas a corresponding coupling in the form of a star would not function since it would be necessary to form 9/root (3)=5.2 turns 54 with a wire diameter equal to 1.5*root (root(3))=1.97 mm, which corresponds to a wire too difficult to wind, with a filling level impossible to fulfil. In addition, if more turns 54 were formed, the proportion of filling would increase, but the winding passage would be lost, such that it would no longer be possible to use a non-segmented stator 9.

As a variant, the coupling could be carried out in the form of a triangle with coils in series, or in the form of a star, with coils either in series or in parallel.

In order to optimise the magnetic performance of a winding 17 of this type formed in situ on the stator 9, a ratio is selected between the diameter L8 of the conductive portion 52 of the wire 51, expressed in mm, and a number of turns 54 of each coil 50 contained between 5% and 25%, in particular between 10% and 20%. Thus, for a diameter L8 of approximately 1.5 mm and for 9 turns per coil, the ratio is approximately 16.7%.

In the particular embodiment in FIG. 3, the protection between the set of plates 16 and the winding wire 51 is ensured by an insulator 57 which is over-moulded on the inner faces of the notches 29. In order to facilitate the legibility of the figure, the over-moulded insulator 57 has been represented only on a part of the stator body 13. The face of the tooth root 34 which faces towards the axis X of the stator 9, i.e. the face of the tooth root 34 which is in contact with the air gap 11 extending according to a portion of cylinder, is without an insulator 57. This therefore prevents disruption of the passage of the flux in the air gap 11.

Preferably, the over-moulded insulator 57 covers the axial end faces of the teeth 27 and/or the axial end faces of the yoke 28. In other words, the over-moulded insulator 57 can also cover the axial end faces 23, 24 of the stator body 16.

In comparison with the use of insulating paper, as is the case in FIG. 2, a configuration of this type makes it possible to facilitate the putting into place of the notch insulator, particularly for stators 9 with a small diameter.

According to one embodiment, the air gap L1 is approximately 0.3 mm. The outer diameter L2 of the stator 9 is contained between 40 mm and 60 mm, and is preferably 52 mm. The inner diameter L4 of the stator 9 is contained between 15 mm and 35 mm, in particular between 20 mm and 30 mm, for example approximately 26.8 mm. Advantageously, the wire 51 comprises a conductive portion 52 with a diameter L8 contained between 1 mm and 2 mm, and is preferably 1.06 mm or 1.5 mm, as previously indicated, whereas each coil 50 comprises a number of turns 54 contained between 5 and 20, in particular equal to 9. The thickness L3 of the yoke 28 can advantageously be contained between 2 mm and 5 mm, and is preferably 3.5 mm. In addition, a radial length L 10 of each tooth 27 (cf. FIG. 5) is contained between 5 mm and 15 mm. The smallest notch opening L9 measured between two adjacent tooth roots 34 is approximately 4 mm. The securing holes 40 can have a diameter L6 contained between 0.6 mm and 3 mm, and can for example be 3 mm, whereas the distance L5 between the axis X of the stator 9 and a centre of a securing hole 40 is approximately 47 mm. In addition, the rotor 10 with an axis of rotation Y shown in detail in FIGS. 9 and 10 has permanent magnets. The rotor body 60 comprises a set of metal plates constituted by an axial stack of metal plates. The rotor body 60 can be connected in rotation to the shaft 12 in different ways, for example by force fitting of the ribbed shaft 12 inside the central opening 65 in the rotor 10, or by means of a key device.

Preferably, the ratio between the outer diameter L2 of the stator 9 and an axial length L11 of the rotor 10 is contained between 3 and 4, and is preferably 3.25. This ratio makes it possible to reduce the inertia of the rotor 10, and thus to reduce the time necessary in order to reach a high speed of rotation, corresponding for example to a speed of functioning of an electrical compressor. Advantageously, the ratio between the outer diameter L12 of the rotor 10 and the length L11 of the rotor 10 is contained between 1.1 and 1.8, and is for example approximately 1.6.

According to one embodiment, the rotor 10 has for example an axial length L11 contained between 10 mm and 20 mm, and is preferably 16 mm, an outer diameter L12 contained between 20 mm and 50 mm, in particular contained between 24 min and 34 mm, and preferably approximately 26 mm, and an inner diameter L13 of approximately 10 mm.

The rotor 10 of the type with embedded magnets 62 comprises a plurality of cavities 61, in each of which there is accommodated at least one permanent magnet 62. The magnets 62 have radial magnetisation, i.e. the two faces 63, 64 which are parallel to one another having an orthoradial orientation are magnetised such as to be able to generate a magnetic flux according to an orientation which is radial relative to the axis Y.

As can be seen clearly in FIG. 10, where the letters N and S correspond respectively to the North and South poles, the magnets 62 situated in two consecutive cavities 61 have alternating polarities.

In the present case, the permanent magnets 62 have a rectangular parallelepiped form, the angles of which are slightly bevelled. The inner and outer faces 63, 64 of each magnet 62 are in this case flat. As a variant, the outer face 64 of each magnet 62 is curved, whereas the inner face 63 of the magnet 62 is flat, or conversely. Alternatively, the two faces 63, 64 are curved in the same direction, such that each magnet 62 has globally the form of a tile.

In addition, the magnets 62 do not fill the cavities 61 completely, such that two empty spaces 67 exist on both sides of a given magnet 62 in an orthoradial direction. The volume of air delimited by all of the spaces 67 of the rotor makes it possible to reduce the inertia of the rotor 10 and to optimise the magnetic flux.

The magnets 62 are preferably made of rare earth, in order to maximise the magnetic power of the machine 7. As a variant, they can however be made of ferrite, according to the applications and the power required from the electrical machine 7. Alternatively, the magnets 62 can be of different grades in order to reduce the costs.

In addition, positioning elements 70 are interposed between the rotor body 60 and each magnet 62, in order to ensure the retention of each permanent magnet 62 inside the corresponding cavity 61. The positioning elements 70 are positioned on the axis Y side of the rotor 10. As a variant, the positioning elements 70 could be positioned on the air gap 11 side of the electrical machine.

Each positioning element 70 is constituted by a resiliently deformable curved spring strip. As a variant, the positioning element 70 is constituted by a pin, a spiral spring, or a spring which is fitted compressed by compression according to its height between the rotor body 60 and the permanent magnets 62. For further details on the configuration of the rotor 10, reference can be made to French application no. 15 54136 filed on 7 May 2015 by the applicant, and which is incorporated by reference in the present application.

It will be appreciated that the foregoing description has been provided purely by way of example, and does not limit the field of the invention, a departure from which would not be constituted by replacement of its different elements by any other equivalents.

1. A stator of a rotary electrical machine, wherein the machine is designed for an electrical compressor for a motor vehicle, the said stator comprising a body with:
a yoke;
a plurality of teeth distributed angularly on an inner periphery of the yoke, with two adjacent teeth defining a notch between one another; and
a winding comprising a plurality of coils, each coil being formed by a wire wound around a tooth,
wherein a ratio between a diameter of a conductive portion of the said wire and an inner diameter of the stator is contained between 5 and 7%.

2. The stator according to claim 1, wherein the ratio is substantially equal to 5.4%.

3. The stator according to claim 1, wherein the diameter of the conductive portion of the wire is contained between 1 mm and 2 mm.

4. The stator according to claim 1, wherein the inner diameter of the stator is approximately 26.8 mm.

5. The stator according to claim 1, wherein each notch has a filling proportion of approximately:
50% when the proportion is calculated according to a first calculation method, wherein there is determination of a ratio between the cumulative total surface area of conductor, including its insulating layer, and a total surface area of the notch, with deduction of a space occupied by a notch insulator, or
73% when the proportion is calculated according to a second calculation method, corresponding to the first method, except that the surface area of a cross-section for the passage of a winding needle is deducted from the surface area of notch cross-section.

6. The stator according to claim 1, wherein the winding is of the in situ type.

7. The stator according to claim 1, wherein a ratio between a diameter of a conductive portion of the non-enameled wire, expressed in mm, and a number of turns of each coil, is contained between 10% and 20%.

8. The stator according to claim 1, wherein each coil is formed by a number of turns contained between 5 and 20.

9. The stator according to claim 8, further comprising six coils.

10. The stator according to claim 1, wherein the winding is of the three-phase type, each phase being formed by two diametrically opposite coils.

11. The stator according to claim 1, wherein the coils are connected electrically in pairs in parallel.

12. The stator according to claim 1, wherein the coils are coupled in the form of a triangle.

13. The stator according to claim 1, wherein, around each tooth, a number of turns situated on the side of the yoke is larger than a number of turns situated on the side of an axis of the said stator.

14. The stator according to claim 1, wherein, in a notch, a portion of the coil filling the said notch is formed by three layers of turns.

15. The stator according to claim 1, wherein a ratio between a smaller notch opening measured between two adjacent tooth roots, and an outer diameter of the stator, is contained between 5% and 15%.

16. A rotary electrical machine comprising:
a stator according to claim 1; and
a rotor provided with embedded permanent magnets.
